(19) United States
(12) Patent Application Publication
(10) Pub. No.: US 2021/0365780 A1
(43) Pub. Date: Nov. 25, 2021

(54) METHOD OF GENERATING MODEL AND INFORMATION PROCESSING DEVICE

(71) Applicant: FUJITSU LIMITED, Kawasaki-shi (JP)

(72) Inventors: Jun LIANG, Kawasaki (JP); Hajime MORITA, Kawasaki (JP)

(73) Assignee: FUJITSU LIMITED, Kawasaki-shi (JP)

(21) Appl. No.: 17/207,746

(22) Filed: Mar. 22, 2021

(30) Foreign Application Priority Data
May 22, 2020 (JP) 2020-090065

(51) Int. Cl. G06N 3/08; G06N 3/04

(52) U.S. Cl. CPC G06N 3/08; G06N 3/0454

(57) ABSTRACT

A non-transitory computer-readable recording medium has stored therein a program that causes a computer to execute a process, the process including updating a parameter of a machine learning model generated by a first machine learning using a plurality of pieces of first training data, by an initial execution of a second machine learning using second training data satisfying a specific condition on the machine learning model, and repeating the second machine learning to update the parameter of the machine learning model, while reducing a degree of influence of the second training data on update of the parameter as a difference between a first value of the parameter before the initial execution of the second machine learning and a second value of the parameter updated by a previous second machine learning increases.

### CROSS-REFERENCE TO RELATED APPLICATION

This application is based upon and claims the benefit of the prior Japanese Patent Application No. 2020-090065, filed on May 22, 2020, the entire contents of which are incorporated herein by reference.

### FIELD

The embodiment discussed herein is related to a model generation technique.

### BACKGROUND

In recent years, a word embedding technique has been used in various tasks such as a document classification using a natural language processing, sentiment analysis, and extraction of unique expressions. The word embedding technique is a technique that associates each of a plurality of words with a word vector.

As for such a word embedding technique using a neural network, for example, Word2vec, Embeddings from Language Models (ELMo), Bidirectional Encoder Representations from Transformers (BERT), and Flair are known. Of these, in ELMo, BERT, and Flair, a word embedding is performed using the context in the text.

In a learning processing that generates a word embedding model such as ELMo, BERT, and Flair, a trained Language Model (LM) is generated by a machine learning on a large amount of text data such as Web data, and a word embedding model is generated from the generated LM. The trained LM is sometimes called a pre-trained model. In this case, since a large amount of text data is used as training data, it takes a longer learning processing than Word2vec.

In relation to the word embedding, an information processing system is known in which a word embedding of words that do not exist in training data is converted into a word embedding that may estimate information related to the class. An adaptive gradient algorithm for on-line learning and a stochastic optimization is also known. A Long Short-Term Memory (LSTM) network, which is a type of recurrent neural network, is also known.

Related techniques are disclosed in, for example, Japanese Laid-Open Patent Publication No. 2016-110284.

Related techniques are also disclosed in, for example: M. E. Peters et al., “Deep contextualized word representations”, Cornell University, arXiv:1802.05365v2, 2018; J. Devlin et al., “BERT: Pre-training of Deep Bidirectional Transformers for Language Understanding”, Cornell University, arXiv:1810.04805v2, 2019; “flairNLP/flair”, [online], GitHub, <URL: https://github.com/zalandoresearch/flair>; J. Duchi et al., “Adaptive Subgradient Methods for Online Learning and Stochastic Optimization”, The Journal of Machine Learning Research, volume 12, pages 2121-2159, 2011; and “Understanding LSTM Networks”, [online], Aug. 27, 2015, <URL: https;//colah.github.io/posts/2015-08-Understanding-LSTMs/>.

### SUMMARY

According to an aspect of the embodiment, a non-transitory computer-readable recording medium has stored therein a program that causes a computer to execute a process, the process including: updating a parameter of a machine learning model generated by a first machine learning using a plurality of pieces of first training data, by an initial execution of a second machine learning using second training data satisfying a specific condition on the machine learning model; and repeating the second machine learning to update the parameter of the machine learning model, while reducing a degree of influence of the second training data on update of the parameter as a difference between a first value of the parameter before the initial execution of the second machine learning and a second value of the parameter updated by a previous second machine learning increases.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram of a functional configuration of a model generation device;

FIG. 2 is a flowchart of a model generation processing;

FIG. 3 is a diagram of a functional configuration illustrating a specific example of the model generation device;

FIG. 4 is a diagram illustrating a word embedding model;

FIG. 5 is a flowchart illustrating a specific example of a model generation processing;

FIG. 6 is a flowchart of a second machine learning; and

FIG. 7 is a diagram of a hardware configuration of an information processing device.

### DESCRIPTION OF EMBODIMENT

A language model LMA may be updated by causing the trained language model LMA, such as ELMo, BERT, and Flair, obtained by a machine learning on a large amount of text data A to learn a small amount of text data B of a new domain. As for the text data A, millions of sentences extracted from, for example, news articles and Internet encyclopedias are used, and as for the text data B about 100,000 sentences extracted from, for example, academic papers in a specific field and in-house data are used.

By generating a new word embedding model from a language model LMB after updating, it is possible to generate a word embedding model which is suitable for the text data B of the new domain.

However, the text data B of the new domain may contain, for example, many technical terms and in-house terms which are not recognized by the language model LMA before updating. In this case, by performing a machine learning on the text data B using a parameter of the language model LMA as an initial value, the parameter is updated to be suitable for the text data B.

However, when only the text data B is used as training data, an overfitting to the text data B often occurs, which does not guarantee that the parameter is suitable for the original text data A. Therefore, the effect of machine learning on the text data A is diminished, and the generalization performance of the language model LMB after updating is impaired, so that the accuracy of the word embedding model generated from the language model LMB is reduced.

In addition, such a problem occurs not only in a machine learning that generates a word embedding model using a neural network, but also in a machine learning that generates various machine learning models.

Hereinafter, an embodiment will be described in detail with reference to the accompanying drawings.

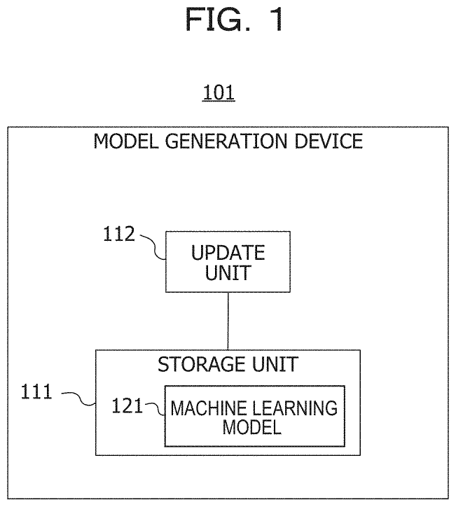

FIG. 1 illustrates an example of a functional configuration of a model generation device according to an embodiment. The model generation device 101 of FIG. 1 includes a storage unit 111 and an update unit 112. The storage unit 111 stores a machine learning model 121 generated by a first machine learning using a plurality of pieces of training data. The update unit 112 performs a model generation processing using the machine learning model 121 stored in the storage unit 111.

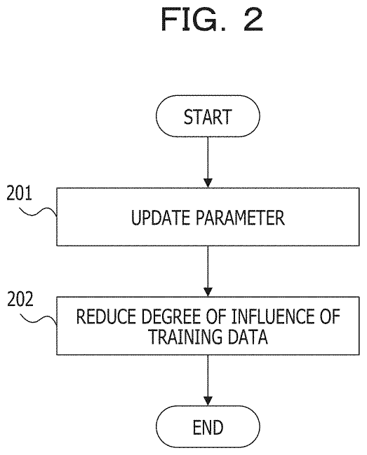

FIG. 2 is a flowchart illustrating an example of a model generation processing performed by the model generation device 101 of FIG. 1. First, the update unit 112 updates a parameter of the machine learning model 121 by executing a second machine learning using training data satisfying a specific condition on the machine learning model 121 (step 201).

Subsequently, the update unit 112 reduces the degree of influence of training data satisfying a specific condition as a difference between the value of the parameter before the second machine learning starts and the updated value of the parameter updated by the second machine learning increases (step 202). The degree of influence of training data satisfying a specific condition represents the degree of influence on the update of a parameter of training data satisfying a specific condition in the second machine learning.

According to the model generation device 101 of FIG. 1, it is possible to suppress an overfitting of a machine learning model in a machine learning by which a trained machine learning model is further trained with training data satisfying a specific condition.

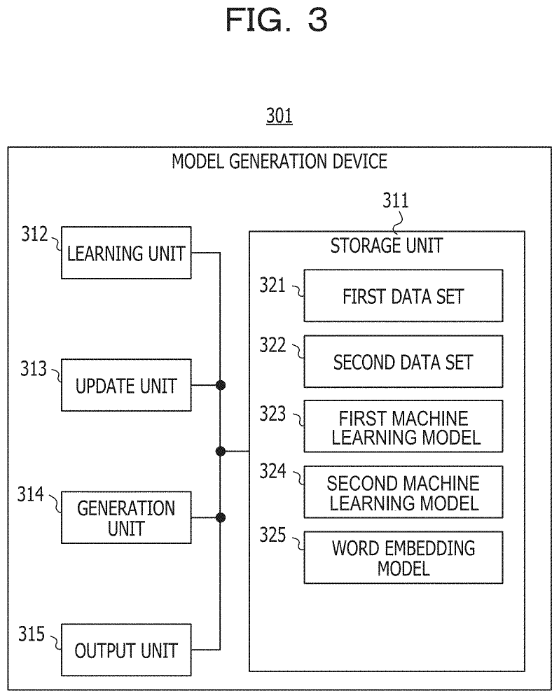

FIG. 3 illustrates a specific example of the model generation device 101 of FIG. 1. A model generation device 301 of FIG. 3 includes a storage unit 311, a learning unit 312, an update unit 313, a generation unit 314, and an output unit 315. The storage unit 311 and the update unit 313 correspond to the storage unit 111 and the update unit 112 of FIG. 1, respectively.

The storage unit 311 stores a first data set 321 and a second data set 322. The first data set 321 includes a large amount of text data used as training data for a first machine learning. As for the first data set 321, millions of sentences extracted from, for example, news articles and Internet encyclopedias are used.

The second data set 322 includes a small amount of text data used as training data for a second machine learning. As for the second data set 322, about 100,000 sentences extracted from, for example, academic papers in a specific field and in-house data are used. The text data of the second data set 322 is an example of training data satisfying a specific condition.

The learning unit 312 generates a first machine learning model 323 by executing the first machine learning using the first data set 321 on an untrained machine learning model, and stores the first machine learning model 323 in the storage unit 311. As for the untrained machine learning model, a Language Model (LM) such as, for example, Embeddings from Language Models (ELMo), Bidirectional Encoder Representations from Transformers (BERT), or Flair is used. This LM is a neural network.

The first machine learning model 323 is a trained machine learning model, and corresponds to the machine learning model 121 of FIG. 1. The output of an intermediate layer of the neural network corresponding to the first machine learning model 323 is used to generate a word vector in a word embedding.

The update unit 313 updates the value of a parameter of the first machine learning model 323 and generates a second machine learning model 324 by executing the second machine learning using the second data set 322 on the first machine learning model 323, and stores the second machine learning model 324 in the storage unit 311. The value of the parameter of the first machine learning model 323 is used as an initial value of a parameter of the second machine learning model 324. In the second machine learning, the update unit 313 performs a control to reduce the degree of influence of the second data set 322 as a difference between the initial value of the parameter and the updated value increases.

The generation unit 314 generates a word embedding model 325 by using the output of the intermediate layer of the neural network corresponding to the second machine learning model 324, and stores the generated word embedding model 325 in the storage unit 311. The word embedding model 325 is a model that associates each of a plurality of words with a word vector. The output unit 315 outputs the generated word embedding model 325.

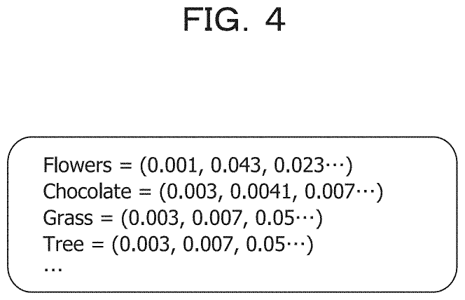

FIG. 4 illustrates an example of the word embedding model 325. In the word embedding model 325 of FIG. 4, “Flowers”, “Chocolate”, “Grass”, and “Tree” are associated with word vectors where the components thereof are real numbers.

For example, the LM of ELMo is a bidirectional LM in which a forward LM and a reverse LM are combined with each other. The forward LM represents a contextual dependency between any word that appears in text data and a plurality of words that appear before that word. The reverse LM represents a contextual dependency between any word that appears in text data and a plurality of words that appear after that word. By combining the forward LM and the reverse LM with each other, it is possible to correctly grasp the meaning of a word that appears in text data.

The LM of ELMo is composed of a plurality of layers, and each layer contains a plurality of Long Short-Term Memories (LSTMs). A word vector corresponding to each word of the word embedding model 325 is generated by using a value output from the LSTM of an intermediate layer among the layers.

For example, an LSTM includes an input gate, an oblivion gate, and an output gate (tanh), and the output of the LSTM is generated by using the outputs of these gates. Parameters of each gate are a weighting factor and a bias, and the weighting factor and bias are updated by machine learning on text data.

As for an optimization algorithm for updating each parameter of the LSTM, for example, an adaptive gradient algorithm called AdaGrad may be used. When AdaGrad is used, a parameter θ is updated by, for example, the following equations.

v=v+g(θ)² (1)

θ=θ−(α/(v^{1/2}+ε))g(θ) (2)

The symbol “v” in Equation (1) is a scalar. The symbol “g(θ)” represents the gradient of an objective function with respect to the parameter θ and is calculated using training data. The symbol “v” increases each time it is updated. The symbol “ε” in Equation (2) is a constant for stabilizing an update processing, and the symbol “a” is the learning rate. The symbol “ε” may have a value of about 10\hat{ }(−8), and the symbol “α” may have a value of about 10\hat{ }(−2). The “(α/(v^{1/2}+ε)) g(θ)” represents the update amount of the parameter θ.

When the LM of ELMo is used as an untrained machine learning model, the weighting factors and biases of the input gate, the oblivion gate, and the output gate of each LSTM included in the LM are used as the parameter ε. In the first machine learning, the learning unit 312 updates the weighting factors and biases of the input gate, the oblivion gate, and the output gate of each LSTM by Equations (1) and (2). By repeating an update processing of the weighting factors and the biases multiple times, an LM1 corresponding to the first machine learning model 323 is generated.

In the second machine learning, the update unit 313 updates the weighting factors and biases of the input gate, the oblivion gate, and the output gate of each LSTM included in the LM1 by the following equations.

v=exp(λ|θ1−θ|) (3)

θ=θ−(α/(v^{1/2}+ε))g(θ) (4)

The symbol “exp( )” in Equation (3) is an exponential function, and the symbol “λ” is a predetermined constant. The symbol “θ1” represents the value of the parameter θ included in the LM1 and is used as an initial value of the parameter θ in the second machine learning. The “|θ1−θ|” represents a difference between θ1 and the updated value of the last updated parameter e. The symbol “v” increases each time it is updated.

Equation (4) is the same as Equation (2). In this case, “g(θ)” is calculated using the second data set 322, and the update amount of the parameter θ is calculated using g(θ) and |θ1−θ|. Then, the updated value of the parameter θ is further updated using the calculated update amount. By calculating the update amount using |θ1−θ|, a difference between the initial value and the updated value of the parameter θ may be reflected on the next update amount. Then, by repeating an update processing of the weighting factors and biases multiple times, an LM2 corresponding to the second machine learning model 324 is generated.

From Equations (3) and (4), it may be seen that as |θ1−θ| increases, “v” increases and “α/(v^{1/2}+ε)” on the right side of Equation (4) decreases. The “α/(v^{1/2}+ε)” represents the degree of influence of g(θ) on the update of the parameter θ. Since g(θ) is calculated using the second data set 322, the degree of influence of g(θ) represents the degree of influence of the second data set 322. Since “v” is small while the value of θ is close to θ1, the influence of the second data set 322 on the update of the parameter θ increases. Meanwhile, when the value of θ moves away from θ1, “v” increases, and the influence of the second data set 322 on the update of the parameter θ decreases.

Accordingly, in the second machine learning using only the second data set 322, an overfitting to the second data set 322 may be suppressed, and the second machine learning model 324 which is suitable for both the first data set 321 and the second data set 322 may be generated. Thus, the generalization performance of the second machine learning model 324 is ensured, and the accuracy of the word embedding model 325 generated from the second machine learning model 324 is improved.

In the second machine learning, the update unit 313 may update the parameter θ by using the following equations instead of Equations (3) and (4).

v1=v1+g(θ)² (5)

v2=exp(λ|θ1−θ|) (6)

θ=θ−(α/(v1^{1/2}−v2^{1/2}+ε))g(θ) (7)

The symbol “v1” of Equation (5) corresponds to “v” of Equation (1), and “v2” of Equation (6) corresponds to “v” of Equation (3). The “α/(v1^{1/2}+v2^{1/2}+ε))g(θ)” of Equation 7 represents the update amount of the parameter θ. By changing the value of A, a magnitude relationship between v1 and v2 may be adjusted. Instead of “exp( )” in Equations (3) and (6), another exponential function that produces a positive value may be used.

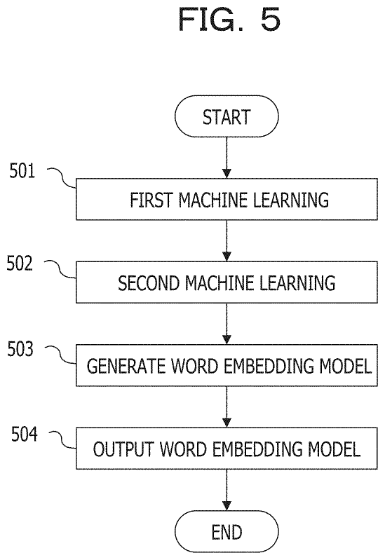

FIG. 5 is a flowchart illustrating a specific example of a model generation processing performed by the model generation device 301 of FIG. 3. In this model generation processing, the LM of ELMo is used as an untrained machine learning model.

First, the learning unit 312 generates the first machine learning model 323 by executing the first machine learning using the first data set 321 on the untrained machine learning model (step 501). Subsequently, the update unit 313 generates the second machine learning model 324 by executing the second machine learning using the second data set 322 on the first machine learning model 323 (step 502).

Subsequently, the generation unit 314 generates the word embedding model 325 using the output of the intermediate layer of the neural network corresponding to the second machine learning model 324 (step 503), and the output unit 315 outputs the word embedding model 325 (step 504).

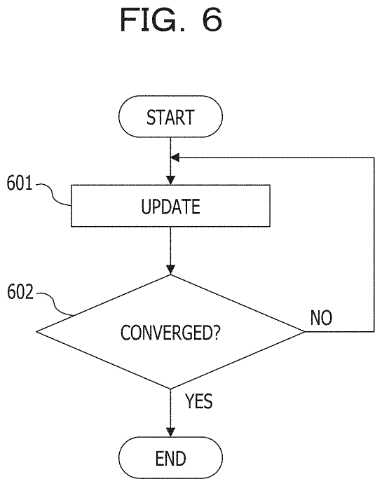

FIG. 6 is a flowchart illustrating an example of a second machine learning in step 502 of FIG. 5. First, the update unit 313 updates the value of each parameter of each LSTM included in the first machine learning model 323 by using the second data set 322 (step 601). The update unit 313 may update the value of each parameter by Equations (3) and (4), or may update the value of each parameter by Equations (5) to (7).

Subsequently, the update unit 313 checks whether the update processing has converged (step 602). For example, when the update amount of each parameter becomes smaller than a threshold value, it is determined that the update processing has converged, and when the update amount is equal to or greater than the threshold value, it is determined that the update processing has not converged.

When the update processing has not converged (step 602, “NO”), the update unit 313 repeats the processing after step 601, and ends the processing when the update processing has converged (step 602, “YES”).

The first machine learning model 323 and the second machine learning model 324 are not limited to the LM for generating the word embedding model 325, and may be a machine learning model that performs other information processings such as natural language processing, image processing, financial processing, and demand forecasting. As for the first machine learning model 323 and the second machine learning model 324, other machine learning models such as a support vector machine and logistic regression may be used in addition to the neural network.

The configurations of the model generation device 101 of FIG. 1 and the model generation device 301 of FIG. 3 are merely examples, and a part of the components may be omitted or changed according to the use purpose or conditions of the model generation device. For example, in the model generation device 301 of FIG. 3, when the first machine learning model 323 is stored in the storage unit 311 in advance, the learning unit 312 may be omitted. When it is not necessary to generate the word embedding model 325, the generation unit 314 and the output unit 315 may be omitted.

The flowcharts of FIGS. 2, 5, and 6 are merely examples, and a part of the processings may be omitted or changed according to the configuration or conditions of the model generation device. For example, in the model generation processing of FIG. 5, when the first machine learning model 323 is stored in the storage unit 311 in advance, the processing of step 501 may be omitted. When it is not necessary to generate the word embedding model 325, the processings of steps 503 and 504 may be omitted.

The word embedding model 325 illustrated in FIG. 4 is merely an example, and the word embedding model 325 changes according to the first data set 321 and the second data set 322.

Equations (1) to (7) are merely examples, and the model generation device may perform an update processing using other calculation equations.

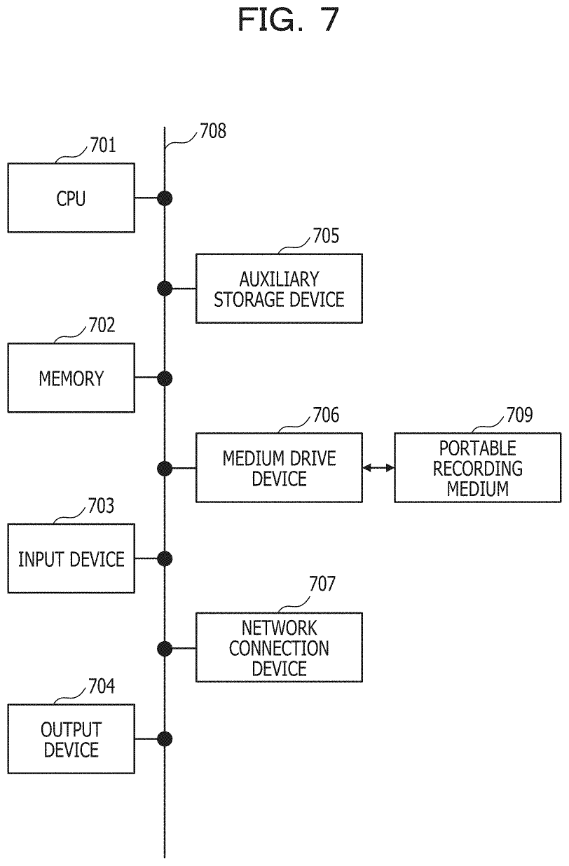

FIG. 7 illustrates a hardware configuration example of an information processing device (computer) used as the model generation device 101 of FIG. 1 and the model generation device 301 of FIG. 3. The information processing device of FIG. 7 includes a central processing unit (CPU) 701, a memory 702, an input device 703, an output device 704, an auxiliary storage device 705, a medium drive device 706, and a network connection device 707. These components are hardware and are connected to each other by a bus 708.

The memory 702 is, for example, a semiconductor memory such as a read only memory (ROM), a random-access memory (RAM), or a flash memory, and stores programs and data used for processings. The memory 702 may operate as the storage unit 111 of FIG. 1 or the storage unit 311 of FIG.3.

The CPU 701 (processor) operates as the update unit 112 of FIG. 1 by executing the programs using, for example, the memory 702. The CPU 701 also operates as the learning unit 312, the update unit 313, and the generation unit 314 of FIG. 3 by executing the programs using the memory 702.

The input device 703 is, for example, a keyboard or a pointing device, and is used to input instructions or information from an operator or a user. The output device 704 is, for example, a display device, a printer, or a speaker, and is used to output inquiries or instructions for the operator or the user and processing results. The processing results may be the second machine learning model 324 or the word embedding model 325. The output device 704 may operate as the output unit 315 of FIG. 3.

The auxiliary storage device 705 is, for example, a magnetic disk device, an optical disk device, a magneto-optical disk device, or a tape device. The auxiliary storage device 705 may be a hard disk drive or a flash memory. The information processing device may store programs and data in the auxiliary storage device 705 and load them into the memory 702 for use. The auxiliary storage device 705 may operate as the storage unit 111 of FIG. 1 or the storage unit 311 of FIG. 3.

The medium drive device 706 drives a portable recording medium 709 to access recorded contents thereof. The portable recording medium 709 is, for example, a memory device, a flexible disk, an optical disk, or a magneto-optical disk. The portable recording medium 709 may be a compact disk read only memory (CD-ROM), a digital versatile disk (DVD), or a universal serial bus (USB) memory. The operator or the user may store programs and data in the portable recording medium 709 and load them into the memory 702 for use.

In this way, a computer readable recording medium that stores programs and data used for processings is a physical (non-temporary) recording medium such as the memory 702, the auxiliary storage device 705, or the portable recording medium 709.

The network connection device 707 is a communication interface circuit that is connected to a communication network such as a local area network (LAN) or a wide area network (WAN) and performs data conversion associated with communication. The information processing device may receive programs and data from an external device via the network connection device 707 and load them into the memory 702 for use. The network connection device 707 may operate as the output unit 315 of FIG. 3.

In addition, the information processing device does not need to include all the components illustrated in FIG. 7, and a part of the components may be omitted according to the use purpose or conditions of the information processing device. For example, when an interface with the operator or the user is unnecessary, the input device 703 and the output device 704 may be omitted. When the portable recording medium 709 or the communication network is not used, the medium drive device 706 or the network connection device 707 may be omitted.

Although the embodiment disclosed herein and advantages thereof have been described in detail, those skilled in the art may make various changes, additions, and omissions without departing from the scope of the disclosure as expressly stated in the claims.

According to an aspect of the embodiment, it is possible to suppress an overfitting of a machine learning model in a machine learning by which a trained machine learning model is further trained with training data satisfying a specific condition.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
updating a parameter of a machine learning model generated by a first machine learning using a plurality of pieces of first training data, by an initial execution of a second machine learning using second training data satisfying a specific condition on the machine learning model; and
repeating the second machine learning to update the parameter of the machine learning model, while reducing a degree of influence of the second training data on update of the parameter as a difference between a first value of the parameter before the initial execution of the second machine learning and a second value of the parameter updated by a previous second machine learning increases.

2. The non-transitory computer-readable recording medium according to claim 1, the process further comprising:
calculating an update amount of the parameter in the second machine learning by using the difference between the first value and the second value.

3. The non-transitory computer-readable recording medium according to claim 1, wherein
the machine learning model is a neural network, and
an output of an intermediate layer of the neural network is used to generate a word vector in word embedding.

4. A method of generating a model, the method comprising:
updating, by a computer, a parameter of a machine learning model generated by a first machine learning using a plurality of pieces of first training data, by an initial execution of a second machine learning using second training data satisfying a specific condition on the machine learning model; and
repeating the second machine learning to update the parameter of the machine learning model, while reducing a degree of influence of the second training data on update of the parameter as a difference between a first value of the parameter before the initial execution of the second machine learning and a second value of the parameter updated by a previous second machine learning increases.

5. The method according to claim 4, further comprising:
calculating an update amount of the parameter in the second machine learning by using the difference between the first value and the second value.

6. The method according to claim 4, wherein
the machine learning model is a neural network, and
an output of an intermediate layer of the neural network is used to generate a word vector in word embedding.

7. An information processing device, comprising:
a memory; and
a processor coupled to the memory and the processor configured to:
update a parameter of a machine learning model generated by a first machine learning using a plurality of pieces of first training data, by an initial execution of a second machine learning using second training data satisfying a specific condition on the machine learning model; and
repeat the second machine learning to update the parameter of the machine learning model, while reducing a degree of influence of the second training data on update of the parameter as a difference between a first value of the parameter before the initial execution of the second machine learning and a second value of the parameter updated by a previous second machine learning increases.

8. The information processing device according to claim 7, wherein
the processor is further configured to:
calculate an update amount of the parameter in the second machine learning by using the difference between the first value and the second value.

9. The information processing device according to claim 7, wherein
the machine learning model is a neural network, and an output of an intermediate layer of the neural network is used to generate a word vector in word embedding.
